(19) United States
(12) Patent Application Publication
(10) Pub. No.: US 2015/0301693 A1
(43) Pub. Date: Oct. 22, 2015

(54) METHODS, SYSTEMS, AND MEDIA FOR PRESENTING RELATED CONTENT

(71) Applicant: Google Inc., Mountain View, CA (US)

(72) Inventors: Aaron Joseph Wheeler, San Francisco, CA (US); Sarah Hatem Ali, San Francisco, CA (US)

(21) Appl. No.: 14/255,523

(22) Filed: Apr. 17, 2014

(51) Int. Cl. G06F 3/0482; G06F 3/0484

(52) U.S. Cl. CPC G06F 3/0482; G06F 3/04847; G06F 3/04842

(57) ABSTRACT

Methods, systems, and media for presenting related content are provided. In some embodiments, the method comprises: causing a first media interface to be presented, wherein the first media interface represents a first plurality of media content items and wherein first metadata is associated with the first media interface; determining, using a hardware processor, that at least one media interface representing related content should be presented; in response to determining that at least one media interface representing related content should be presented, generating a plurality of media interfaces, wherein each of the plurality of media interfaces is associated with metadata related to the first metadata; and causing at least one of the plurality of media interfaces to be presented concurrently with the first media interface.

### TECHNICAL FIELD

The disclosed subject matter relates to methods, systems, and media for presenting related content.

### BACKGROUND

Many users are increasingly interested in viewing media content streamed to user devices with limited screen space, such as mobile phones, tablet computers, and televisions. Users may additionally want to be presented with suggestions of related content to watch. However, on some user devices, it can be difficult to navigate through suggestions of related content, particularly due to limited screen size and limited input options.

Accordingly, it is desirable to provide new methods, systems, and media for presenting related content.

### SUMMARY

In accordance with various embodiments of the disclosed subject matter, methods, systems, and media for presenting related content are provided.

In accordance with some embodiments of the disclosed subject matter, a method for presenting related content is provided, the method comprising: causing a first media interface to be presented, wherein the first media interface represents a first plurality of media content items and wherein first metadata is associated with the first media interface; determining, using a hardware processor, that at least one media interface representing related content should be presented; in response to determining that at least one media interface representing related content should be presented, generating a plurality of media interfaces, wherein each of the plurality of media interfaces is associated with metadata related to the first metadata; and causing at least one of the plurality of media interfaces to be presented concurrently with the first media interface.

In accordance with some embodiments of the disclosed subject matter, a system for presenting related content is provided, the system comprising: a hardware processor that is configured to: cause a first media interface to be presented, wherein the first media interface represents a first plurality of media content items and wherein first metadata is associated with the first media interface; determine that at least one media interface representing related content should be presented; in response to determining that at least one media interface representing related content should be presented, generate a plurality of media interfaces, wherein each of the plurality of media interfaces is associated with metadata related to the first metadata; and cause at least one of the plurality of media interfaces to be presented concurrently with the first media interface.

In accordance with some embodiments of the disclosed subject matter, non-transitory computer-readable media containing computer executable instructions that, when executed by a processor, cause the processor to perform a method for presenting related content, the method comprising: causing a first media interface to be presented, wherein the first media interface represents a first plurality of media content items and wherein first metadata is associated with the first media interface; determining that at least one media interface representing related content should be presented; in response to determining that at least one media interface representing related content should be presented, generating a plurality of media interfaces, wherein each of the plurality of media interfaces is associated with metadata related to the first metadata; and causing at least one of the plurality of media interfaces to be presented concurrently with the first media interface.

In accordance with some embodiments of the disclosed subject matter, a system for presenting related content is provided, the system comprising: means for causing a first media interface to be presented, wherein the first media interface represents a first plurality of media content items and wherein first metadata is associated with the first media interface; means for determining that at least one media interface representing related content should be presented; in response to determining that at least one media interface representing related content should be presented, means for generating a plurality of media interfaces, wherein each of the plurality of media interfaces is associated with metadata related to the first metadata; and means for causing at least one of the plurality of media interfaces to be presented concurrently with the first media interface.

In some embodiments, at least one of the plurality of media interfaces represents a single media content item.

In some embodiments, the system further comprises means for causing the single media content item to be presented in response to selecting one of the plurality of media interfaces.

In some embodiments, at least one of the plurality of media interfaces represents a plurality of media content items.

In some embodiments, the system further comprises means for causing an indicator associated with the first media interface to be presented, wherein a selection of the indicator causes related content represented by one or more of the plurality of media content to be presented.

In some embodiments, the system further comprises means for determining that each of the media content items in the first plurality of media content items has been viewed, wherein the at least one of the plurality of media interfaces is presented adjacent to the first media interface in response to determining that each of the media content items in the first plurality of media content items has been viewed.

In some embodiments, the system further comprises means for causing the at least one of the plurality of media interfaces to be selected in response to receiving a first user input to navigate in a first direction, wherein a second plurality of media content items associated with the selected media interface is presented for browsing.

In some embodiments, the system further comprises: means for determining whether each of the media content items in the second plurality of media content items has been viewed in response to receiving a second user input to navigate in the first direction; and means for causing the at least one of the plurality of media interfaces to be selected in response to determining that each of the media content items in the second plurality of media content items has been viewed, wherein a third plurality of media content items associated with the selected media interface is presented for browsing.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIGS. 1A and 1B show illustrative examples of user interfaces for concurrently presenting media interfaces and a media content item in accordance with some embodiments of the disclosed subject matter.

FIGS. 2A and 2B show illustrative examples of user interfaces for presenting related media content and/or media interfaces representing related content in response to selection of an indicator on a first media interface, in accordance with some embodiments of the disclosed subject matter.

FIGS. 3A-3C show illustrative examples of user interfaces for presenting a media interface representing a playlist of media content items determined to be related to a first media interface and for allowing a user to navigate through the items in the playlist in accordance with some embodiments of the disclosed subject matter.

FIG. 4 shows a schematic diagram of an illustrative example of a system for presenting related content in accordance with some embodiments of the disclosed subject matter.

FIG. 5 shows an illustrative example of hardware that can be used in a server and/or a user device in accordance with some embodiments of the disclosed subject matter.

FIG. 6 shows an illustrative example of a process for generating and presenting one or more media interfaces related to a first media interface in accordance with some embodiments of the disclosed subject matter.

### DETAILED DESCRIPTION

Methods, systems, and media for presenting related content are provided.

In accordance with some embodiments, media interfaces representing media content items can be presented in a user interface, thereby allowing a user to browse and/or navigate through multiple media interfaces to select a media content item to consume. These media interfaces can be presented, for example, in a grid of media interfaces, as a column of media interfaces, as a row of media interfaces, as multiple rows of media interfaces with each row representing a group of related media interfaces, and/or using any other suitable technique or techniques.

In some embodiments, related media content can be presented in a user interface. In some embodiments, the related media content can be presented in response to receiving a user input from a selection mechanism on a media interface associated with media content which is currently being presented. For example, in some embodiments, the mechanisms described herein can cause a presentation of related media content to begin in response to receiving the user input. As another example, in some embodiments, the mechanisms described herein can cause one or more media interfaces which represent related media content to be presented in response to receiving the user input.

Additionally or alternatively, in some embodiments, media interfaces which represent related media content can be presented in response to determining that a user has viewed and/or navigated through all of the media content items in a collection of media content items (e.g., all of the videos in a video playlist). In a more particular example, in response to determining that a user has viewed and/or navigated through a collection of media content items represented by a first media interface, where the first media interface is presented in a horizontal row of media interfaces, the mechanisms described herein can select one or more related media interfaces and insert the related media interfaces adjacent to the first media interface.

In some embodiments, a media interface that is presented concurrently with a presentation of a media content item can be interacted with, for example, within a media player window or any other suitable user interface. In some embodiments, mechanisms described herein can allow a user to navigate through a selection of media interfaces within the media player window while a media content item is simultaneously being presented within the media player window. In response to playing back a video content item, the media interface that identifies the currently played back content item can be presented along with the video content item, and the user can navigate to other media interfaces that represent, for example, related media content. As another example, a user can navigate through a collection of media content items in a playlist and can additionally select a media content item from the playlist to begin playback of that item or place that item in a playback queue.

In some embodiments, the mechanisms described herein can identify related media content based on metadata associated with media content which is currently being presented. Additionally or alternatively, the mechanisms described herein can identify related media content based on an assessed interest level of a user viewing the media content which is currently being presented.

It should be noted that, in some embodiments, a media interface can represent a single media content item and/or a collection of media content items (e.g., a playlist of videos, a playlist of songs, a collection of images, etc.). In some embodiments, a selection of media interfaces presented in a user interface can include a combination of one or more media interfaces each representing single media content items and one or more media interfaces each representing a collection of media content items. For example, in response to concurrently presenting a media interface along with media content identified by the media interface, the user can be provided with an opportunity to navigate through media interfaces that represent other single media content items and/or media interfaces that represent a collection of media content items.

It should also be noted that media content items can be any suitable media content. For example, media content can include audio and/or video media content. As another example, media content can include print media content or image media content. As still another example, media content can include a collection of media content, such as a playlist of videos, a playlist of songs, a collection of images, etc. As a further example, media content can include subscription based media content, such as podcasts, online magazine subscriptions, etc. As another further example, media content can include interactive media content, such as applications and video games. As another further example, media content can include any suitable combination thereof and/or any other suitable media content.

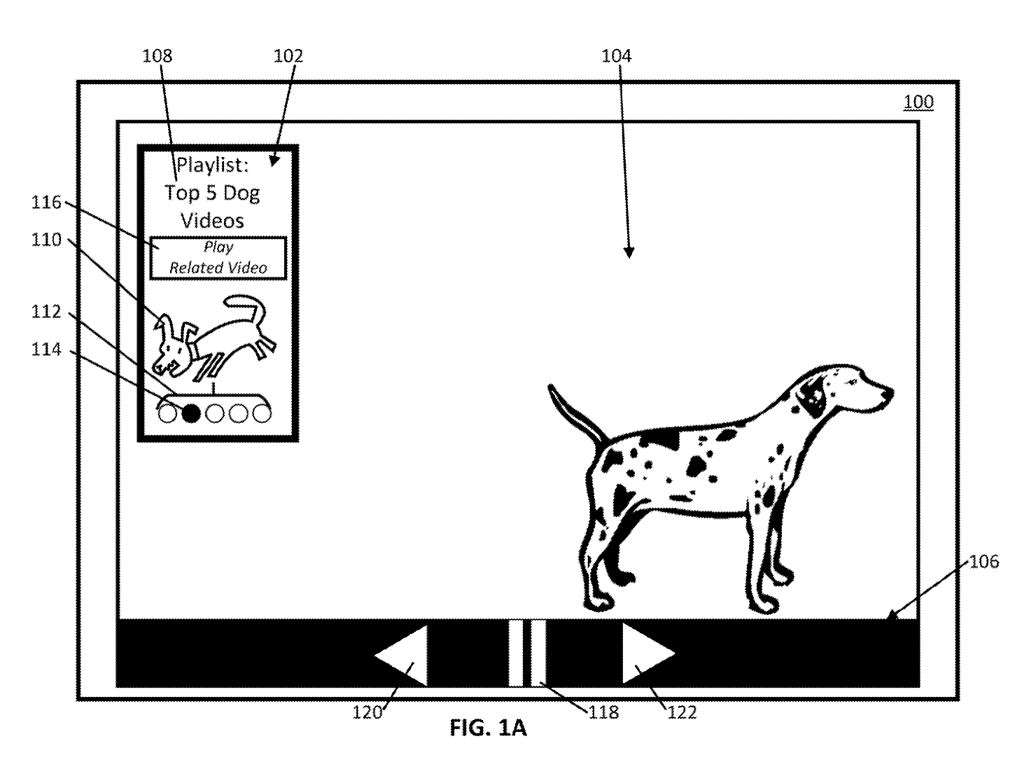

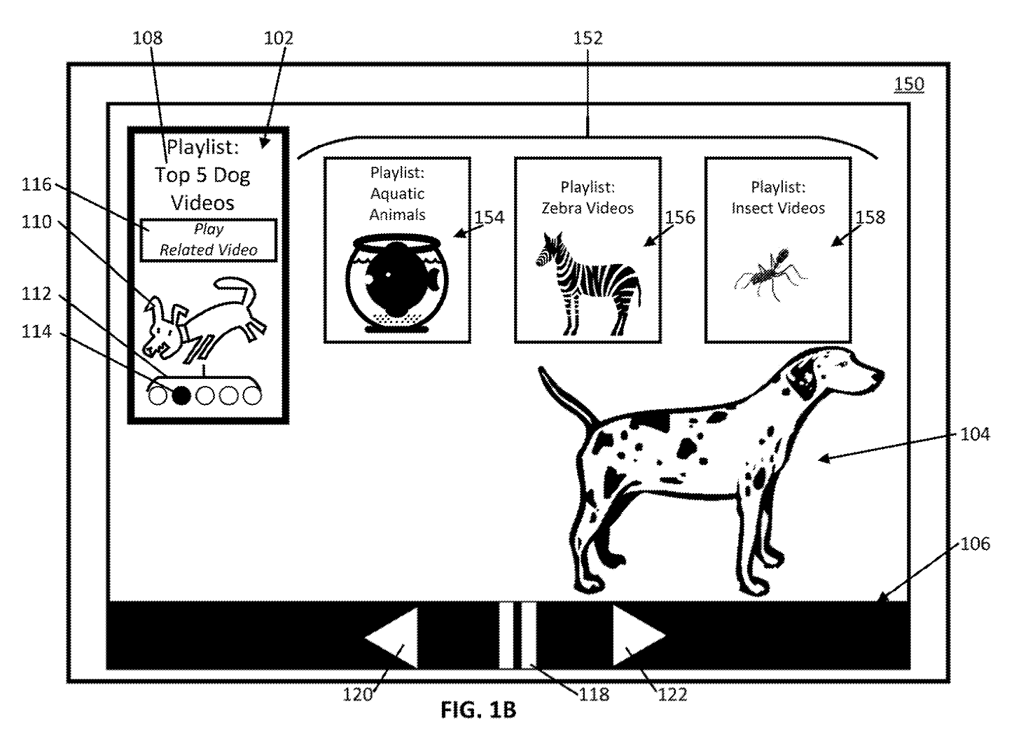

Turning to FIG. 1A, an example 100 of a user interface for concurrently presenting a media interface that represents a playlist of media content items along with a media content item identified in the playlist is shown in accordance with some embodiments of the disclosed subject matter. As illustrated, user interface 100 can include a first media interface 102, a first media content item 104, and media player controls 106.

First media interface 102 can be a user interface component representing a single media content item or a playlist of media content items. The single media content item and/or the playlist of media content items can include any suitable media content items (e.g., video content items, audio content items, audiobooks, television programs, podcasts, images, slideshows, video games, applications, and/or any other suitable media content). In some embodiments, a playlist of media content items can include any suitable number of media content items (e.g., two, three, five, ten, twenty, and/or any other suitable number), and can include any suitable combination of types of media content.

In some embodiments, a media interface, such as first media interface 102, can be interacted with. For example, in some embodiments, selection of a media interface (e.g., by tapping, clicking, swiping, pointing, and/or any other selection method) can cause a media content item represented by the media interface to be presented. As another example, in instances where a media interface represents a playlist or collection of media content items, selection of the media interface can allow the user to navigate through the media content items contained in the playlist (e.g., using directional inputs on a user input device). As a more particular example, in some embodiments, the media content items in the playlist can be navigated when a particular user input is received. As a specific example, in some embodiments, a user input indicating navigation in a particular direction (e.g., to the right, down, and/or any other suitable direction) can cause a subsequent media content item in the playlist to be presented, and a user input indicating navigation in a direction opposite to the particular direction (e.g., to the left, up, and/or any other suitable direction) can cause a preceding media content item in the playlist to be presented.

In some embodiments, first media interface 102 can include a title 108, a thumbnail image 110, a playlist indicator 112, an item indicator 114, and a play related video interface 116.

Title 108 can indicate a title for the single media content item or for the playlist represented by first media interface 102 in any suitable manner. For example, as shown in FIG. 1A, title 108 can be a block of text. In some embodiments, title 108 can include any suitable images, graphics, icons, animations, and/or any other suitable content. The position of title 108 in first media interface 102 is merely an example, and title 108 can be presented at any suitable position. In some embodiments, title 108 can be omitted.

Thumbnail 110 can be an image associated with the single media content item or the playlist of media content items represented by first media interface 102. For example, in some embodiments, thumbnail 110 can be an image associated with the topic of the single media content item or of the playlist of media content items. As another example, in some embodiments, thumbnail 110 can be a screen capture of a frame from the single media content item or one of the media content items in the playlist represented by media interface 102. As yet another example, in some embodiments, thumbnail 110 can be an image associated with a creator of the single media content item or of the playlist of media content items (e.g., a logo of an entity, an avatar of a user, and/or any other suitable image). The position of thumbnail 110 in first media interface 102 is merely an example, and thumbnail 110 can be presented at any suitable position. In some embodiments, thumbnail 110 can be omitted.

It should be noted that elements, such as titles, thumbnail images, and/or other media identifier elements, that are presented can be based on one or more items of metadata associated with the media content with which the media identifier element is associated. For example, the media identifier element can include title information based on title metadata of the media content. As another example, the media identifier element can include an image based on thumbnail metadata of the media content and/or a frame of image data from the media content.

In instances where first media interface 102 represents a playlist, playlist indicator 112 can indicate the number of media content items contained in the playlist in any suitable manner. For example, as shown in FIG. 1A, playlist indicator 112 can include a series of icons, each of which corresponds to one media content item within the playlist. In a more particular example, playlist indicator 112 can include a playback indicator that indicates which of the media content items within the playlist is currently being played back (e.g., a red circle) and a navigation indicator that indicates which of the media content within the playlist has been navigated to (e.g., a gray circle). Any suitable icon(s) (e.g., squares, triangles, images, and/or any other suitable icons) can be used. As another example, in some embodiments, playlist indicator 112 can include a text numeral, which can indicate the number of media content items within the playlist. The position of playlist indicator 112 in first media interface 102 is merely an example, and playlist indicator 112 can be presented at any suitable position. In some embodiments, playlist indicator 112 can be omitted.

In instances where first media interface 102 represents a playlist of media content items, item indicator 114 can indicate which media content item from the playlist is currently being presented. In some embodiments, item indicator 114 can include a member of playlist indicator 112 highlighted in a manner to indicate the media content item currently being presented, for example, as shown in FIG. 1A. In some embodiments, item indicator 114 can be omitted.

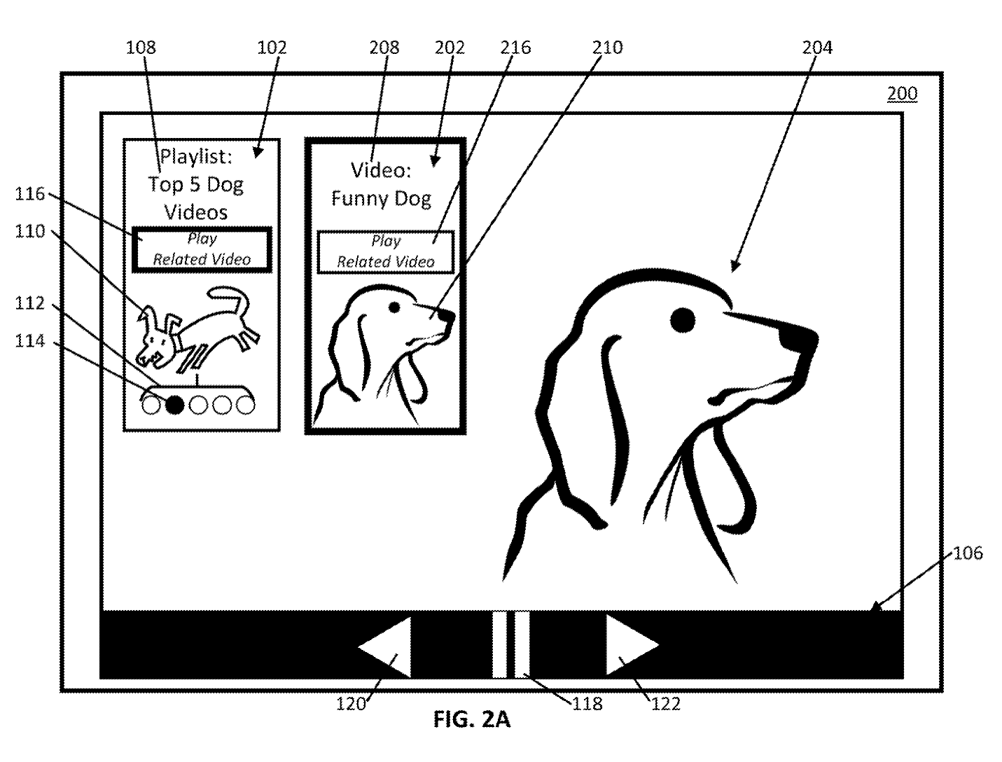

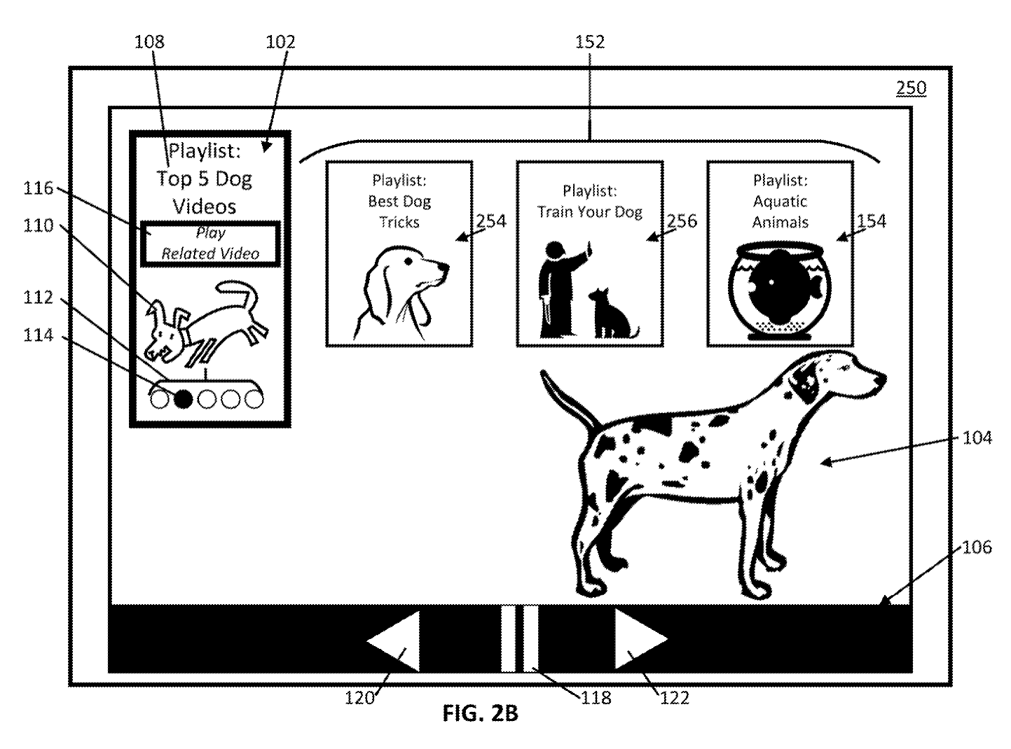

Play related videos interface 116 can be used to receive a request indicating that a user wants media content related to media content item 104 to be presented. In some embodiments, selection of play related videos interface 116 can cause media content related to media content item 104 to be presented, for example, as shown in and described below in connection with FIG. 2A. In some embodiments, selection of play related videos interface 116 can cause one or more media interfaces each representing a media content item or a playlist of media content items related to media content item 104 to be presented, for example, as shown in and described below in connection with FIG. 2B.

Play related videos interface 116 can be any suitable user interface component. For example, as shown in FIG. 1A, play related videos interface 116 can be a selectable input, which can be clicked, tapped, and/or selected in any other suitable manner (e.g., using a touchscreen, a keyboard, a mouse, a remote control, and/or any other suitable input device). As another example, in some embodiments, play related videos interface 116 can be invisible on first media interface 102. In some embodiments, play related videos interface 116 can correspond to any particular input which can cause a related media content item to be presented. As a more particular example, in some embodiments, play related videos interface 116 can correspond to a particular button on an external input device (e.g., a particular keystroke on a keyboard, a particular mouse button, a particular button on a remote control, and/or any other suitable external device input).

First media content item 104 can be a presentation of any suitable media content. For example, in some embodiments, first media content item 104 can be a presentation of a media content item contained in the playlist represented by first media interface 102. In some embodiments, first media interface 102 can be presented concurrently with first media content item 104, for example, as shown in FIG. 1A. The position of first media interface 102 in user interface 100 is shown merely as an example, and first media interface 102 can be presented in any suitable position.

Media player controls 106 can be any suitable controls used for controlling the presentation of first media content item 104. For example, as shown in FIG. 1A, media player controls 106 can include a pause button 118, a rewind button 120 and a fast-forward button 122. Although three buttons are shown in media player controls 106, in some embodiments, any suitable number of buttons can be included. For example, in some embodiments, buttons and/or controls corresponding to volume adjustment, screen maximization, and/or any other suitable controls can be included. In some embodiments, media player controls 106 can be fixed at a location within a player window and can be permanently displayed. In some other embodiments, presentation of media player controls 106 can be triggered by a user action, for example, by a user moving a cursor over a particular area of a media player window or by the user providing a particular directional input. In some embodiments, media player controls 106 can be omitted.

Pause button 118, rewind button 120, and fast-forward button 122 can be used to control the presentation of media content 104. For example, in some embodiments, pause button 118 can be used to pause presentation of media content 104. In some embodiments, if pause button 118 is selected (e.g., by clicking with a mouse, tapping on a touch screen, and/or any other selection technique), pause button 118 can be replaced by a play button (not shown). As another example, rewind button 120 can be used to rewind media content 104 to an earlier point in the media content than what is currently being presented. Similarly, fast-forward button 122 can be used to skip media content 104 to a later point in the media content than what is currently being presented.

In some embodiments, multiple media interfaces can be presented concurrently with a presentation of a media content item in a media player window, as shown in user interface 150 of FIG. 1B. As shown, user interface 150 can include media interface 102, which can correspond to media content 104, and collection of media interfaces 152.

Collection of media interfaces 152 can include any suitable number of media interfaces (e.g., one, two, three, five, and/or any other suitable number), such as media interfaces 154, 156, and 158. In some embodiments, the media interfaces presented in collection of media interfaces 152 can be presented in a similar manner to media interface 102. Alternatively, in some embodiments, media interfaces 154, 156, and/or 158 can be presented in a different manner. For example, as shown in FIG. 1B, media interfaces 154, 156, and/or 158 can be presented in a smaller size than media interface 102. As another example, media interfaces 154, 156, and/or 158 can be presented with different and/or limited information than media interface 102. Additionally or alternatively, in some embodiments, media interfaces 154, 156, and/or 158 can be presented in a different color, with different fonts, with a different border, and/or any other differences, compared to media interface 102. Note that the position of collection of media interfaces 152 is shown merely as an example, and collection of media interfaces 152 can be located at any suitable position (e.g., below media interface 102, to the left of media interface 102, in a pop-up window, and/or any other suitable position).

In some embodiments, media interfaces 102, 154, 156, and 158 can be associated with a particular category and/or a particular channel. For example, in some embodiments, media interfaces 102, 154, 156, and 158 can all be associated with a channel corresponding to a particular provider of media content (e.g., a particular publishing entity, a particular artist, a particular band, a particular television channel, and/or any other suitable provider of media content).

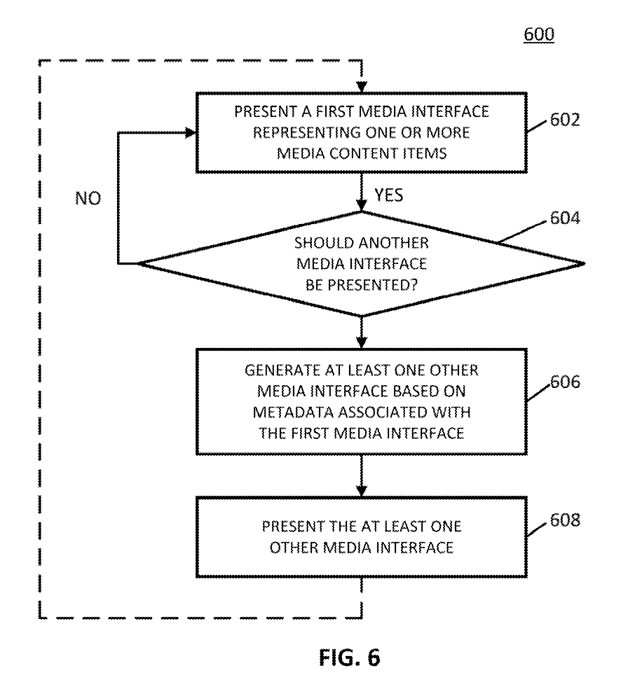

In some embodiments, the selection of play related video interface 116 can cause a second media content item determined to be related to first media content item 104 to be presented instead of first media content item 104. In some embodiments, a second media interface associated with the second media content item can be concurrently presented with the second media content item, for example, as described below in connection with FIG. 6. FIG. 2A shows an example 200 of a user interface for concurrently presenting the second media interface and the second media content item.

In some embodiments, user interface 200 can include a second media interface 202 and a second media content item 204.

Second media content item 204 can be presented in any suitable manner. For example, in some embodiments, the mechanisms described herein can cause presentation of first media content item 104 to stop, and can cause presentation of second media content item 204 to begin in the same media player window as was used to present first media content item 104.

Similarly to first media interface 102, in some embodiments, second media interface 202 can include a title 208, a thumbnail 210, and a play related video interface 216, which can be similar in appearance and function to title 108, thumbnail 110, and play related video interface 116, as shown in and described above in connection with FIG. 1A. The positions of title 208, thumbnail 210, and play related video interface 216 in second media interface 202 are shown merely as examples, and title 208, thumbnail 210, and/or play related video interface 216 can be presented at any suitable positions. In some embodiments, any of title 208, thumbnail 210, and/or play related video interface 216 can be omitted.

In some embodiments, the selection of play related video interface 116 can cause one or more media interfaces which represent media content related to media content represented by a media interface associated with play related video interface 116 (e.g., media interface 102) to be presented. FIG. 2B shows an example 250 of a user interface for inserting media interfaces which represent related media content into a collection of media interfaces.

As shown, in some embodiments, user interface 250 can include one or more media interfaces which represent content related to media interface 102 and/or media content item 104, such as inserted media interfaces 254 and 256. Note that, although media interfaces 254 and 256 each represent a playlist, in some embodiments, media interfaces 254 and/or 256 can alternatively represent single media content items. As shown in FIG. 2B, in some embodiments, inserted media interfaces 254 and/or 256 can be inserted in collection of media interfaces 152. As a more particular example, in some embodiments, inserted media interfaces 254 and 256 can cause media interface 154 to be shifted to the right, and can cause media interfaces 156 and/or 158 to be shifted out of the viewport in which user interface 250 is presented. Additionally or alternatively, in some embodiments, inserted media interfaces 254 and/or 256 can be inserted to the right of media interface 158, and insertion of inserted media interfaces 254 and/or 256 can cause media interface 154 and/or 156 to be removed from user interface 250. In some embodiments, inserted media interfaces 254 and/or 256 can be added to collection of media interfaces 152 without removing any of media interfaces 154, 156, and/or 158. In some embodiments, media interfaces in collection of media interfaces 152 can be presented in a smaller size to allow all of the media interfaces to fit in the media player window.

In some embodiments, media interfaces 254 and/or 256 can be selected and/or generated based on any suitable information and using any suitable techniques. For example, in some embodiments, media interfaces 254 and/or 256 can be selected and/or generated such that the media content represented by the media interfaces is associated with metadata which is determined to be relevant to metadata associated with media interface 102 and/or media content item 104. More particular examples for selecting and/or generating media interfaces representing related content based on metadata and/or other information is described below in connection with FIG. 6.

Note that, in some embodiments, media content items and/or media interfaces which represent related media content which are presented as a result of the selection of play related videos interface 116 can be limited and/or constrained to media content created, produced, and/or distributed by a particular entity. For example, in some embodiments, media content and/or media interfaces can be limited to media content associated with a particular artist, television channel, radio station, producer, publishing corporation, and/or any other suitable entity.

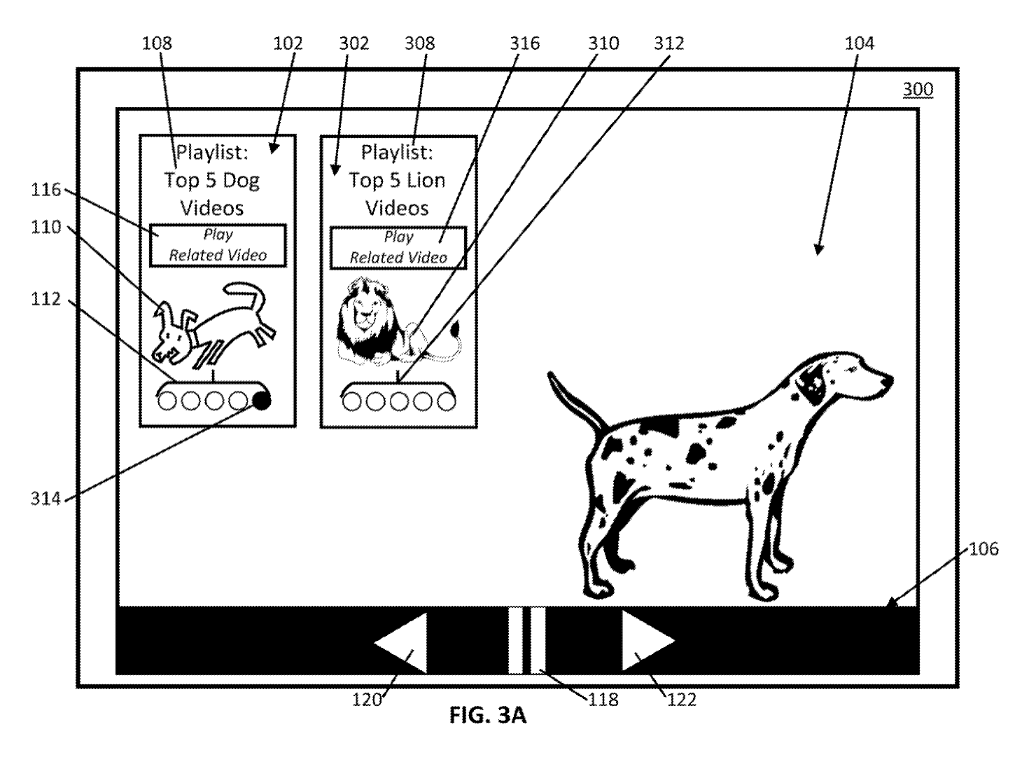

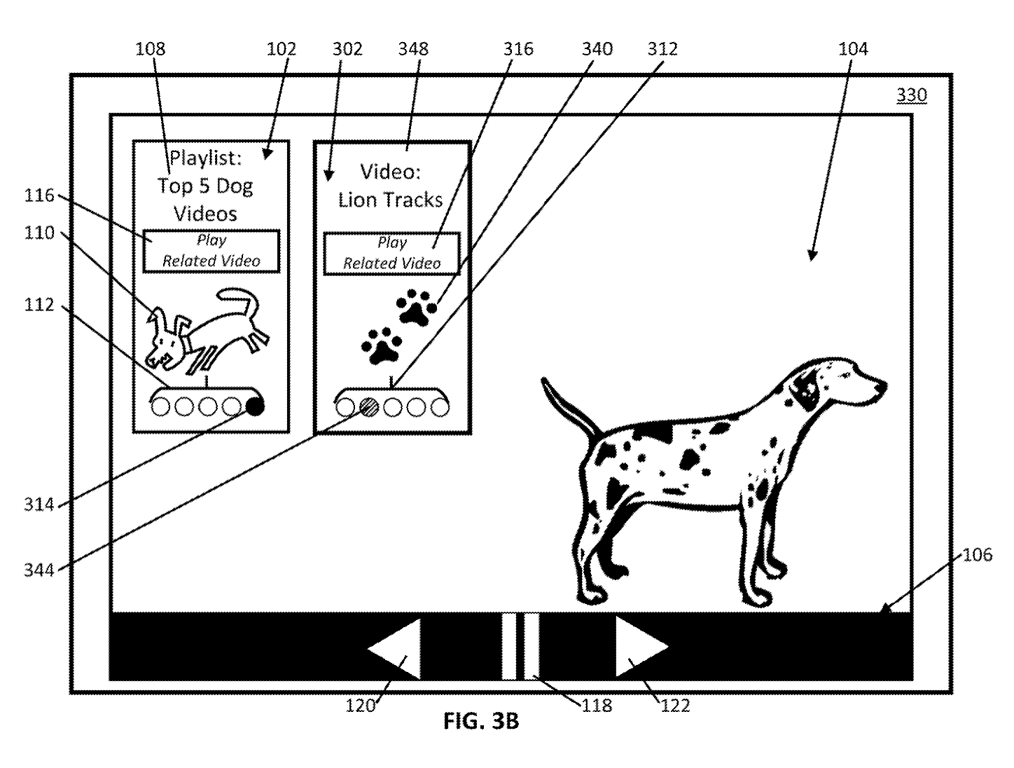

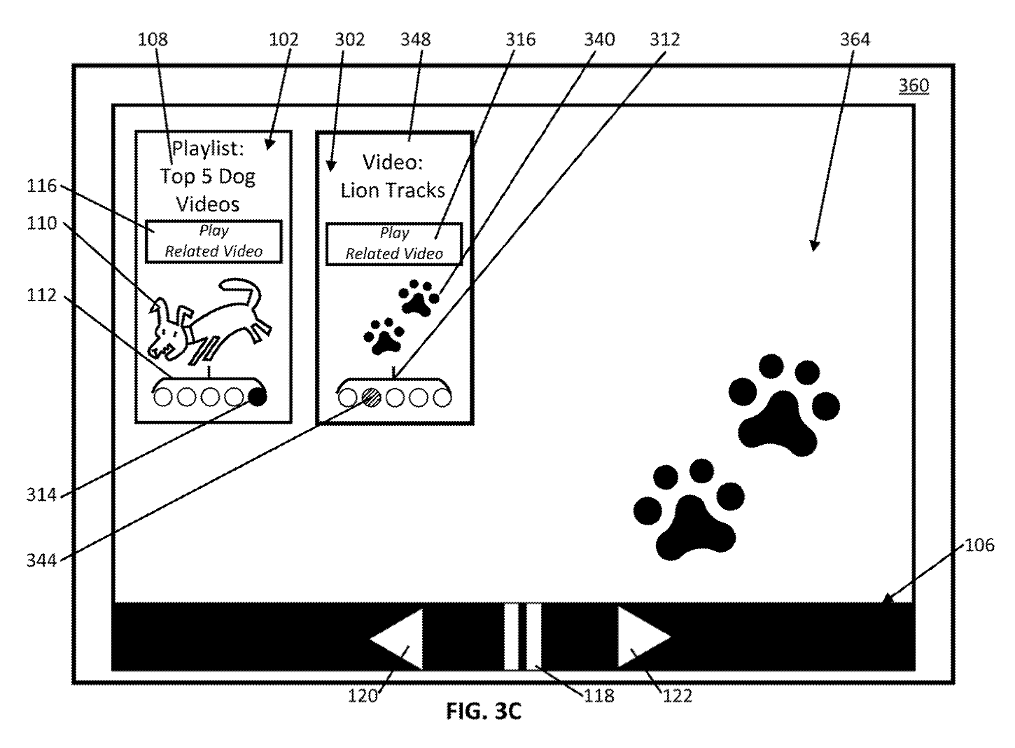

Turning to FIG. 3A, an example 300 of a user interface for presenting a second media interface representing a playlist of media content items related to a first media interface is shown in accordance with some embodiments of the disclosed subject matter.

As illustrated, FIG. 3A can include a second media interface 302, which can include a title 308, a thumbnail 310, a playlist indicator 312, and a play related videos interface 316. Title 308, thumbnail 310, playlist indicator 312, and play related videos interface 316 can be similar to title 108, thumbnail 110, playlist indicator 112, and play related videos interface 116 as shown in and described in connection with FIG. 1.

Second media interface 302 can be presented in any suitable position. For example, as shown in FIG. 3A, second media interface 302 can be presented next to first media interface 102 (e.g., to the right, to the left, above, under, and/or any other suitable position) in a media player window. As another example, in some embodiments, second media interface 302 can be presented instead of first media interface 102. Although only one media interface representing related content (e.g., second media interface 302) is shown in FIG. 3A, any suitable number of media interfaces (e.g., two, three, four, and/or any other suitable number) can be presented.

In some embodiments, a playlist represented by second media interface 302 can be selected and/or identified based on how relevant metadata associated with the playlist is to media interface 102 and/or media content item 104. Alternatively, in some embodiments, a playlist represented by second media interface 302 can be assembled such that each media content item in the playlist is selected based on how relevant metadata associated with the individual media content items is to metadata associated with media interface 102 and/or media content item 104.

FIG. 3B shows an example 330 of a user interface which can be presented in response to receiving input from a user indicating that the user wants to navigate to second media interface 302 and/or navigate a collection of items in a playlist represented by second media interface 302. As illustrated, user interface 330 can include an item indicator 344, a video thumbnail 340, and a video title 348.

As shown in FIG. 3B, second media interface 302 can be presented with highlighting and/or emphasis to indicate that media interface 302 is a focus of user interface 330. For example, in some embodiments, second media interface 302 can be presented with a different border, a different font, a different color, and/or any other suitable difference, compared to first media interface 302.

Item indicator 344 can indicate a media content item in a playlist represented by second media interface 302 which a user has navigated to. For example, in some embodiments, a user can scroll between items in the playlist, and item indicator 344 can be updated as the user scrolls between items to indicate the current item. In some embodiments, item indicator 344 can be the same as item indicator 314 (which can indicate the media content item currently being presented). In other embodiments, item indicator 344 can differ from item indicator 314 in shading, color, shape, size, and/or any other suitable difference.

In some embodiments, as a user scrolls between items in the playlist represented by media interface 302, video thumbnail 340 and/or video title 348 can be updated to correspond to the media content item the user has scrolled to, for example, as shown in FIG. 3B.

FIG. 3C shows an example 360 of a user interface that can be presented in response to a user selecting a particular media content item from a playlist represented by second media interface 302. As shown, in response to receiving a user selection, the mechanisms described herein can cause the associated media content item to be presented. In the particular example shown in FIG. 3C, presentation of a video 364 can begin. Additionally, note that video 364, as shown in FIG. 3C, corresponds to the second item in the playlist represented by second media interface 302, as indicated by item indicator 344, thumbnail 340, and title 348.

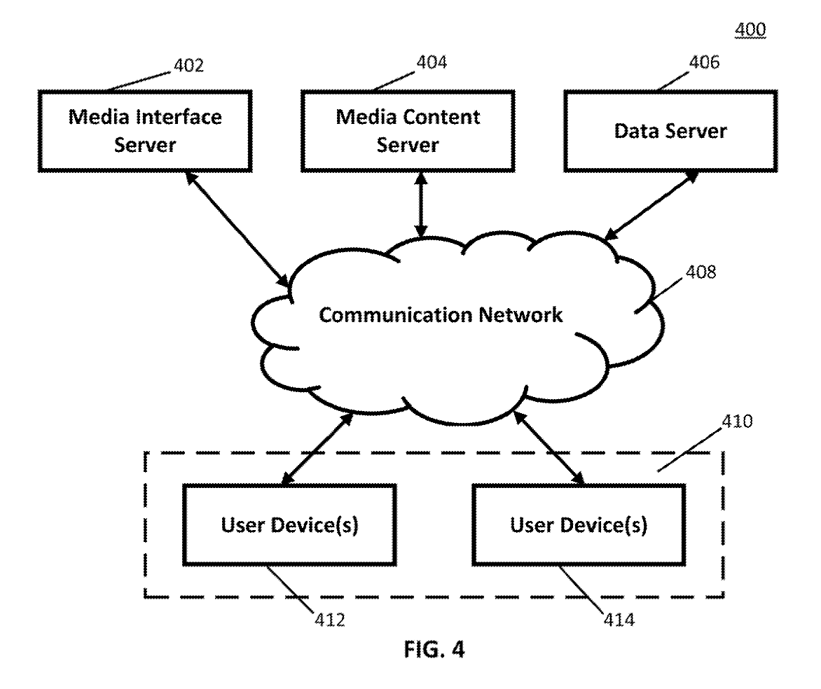

Turning to FIG. 4, an example 400 of hardware for presenting related content that can be used in accordance with some embodiments is shown. As illustrated, hardware 400 can include one or more servers, including a media interface server 402, a media content server 404, and a data server 406, a communication network 408, and one or more user devices 410, such as user devices 412 and 414.

Media interface server 402 can be any suitable server for storing media interfaces and/or parameters associated with media interfaces and for presenting media interfaces to a user device 410 in some embodiments. For example, media interface server 402 can store parameters associated with the appearance of media interfaces (e.g., colors, images, icons, and/or any other suitable parameters). Additionally or alternatively, media interface server 402 can serve media interfaces to a user device 410 via communication network 408. In some embodiments, media interface server 402 can be omitted.

Media content server 404 can be any suitable server for storing media content and delivering the content to a user device 410 in some embodiments. For example, media content server 404 can be a server that streams media content to user device 410 via communication network 408. As a more particular example, in some embodiments, media content server 404 can transmit media content to user device 410 in response to receiving a request to buy, rent, and/or borrow the media content. As another example, in some embodiments, media content server 402 can be a server that transmits the media content to user device 410 in response to receiving a request from user device 410 to buy, rent, and/or borrow the media content. Media content provided by media content server 402 can be any suitable content, such as video content, audio content, television programs, movies, cartoons, sound effects, audiobooks, streaming live content (e.g., a streaming radio show, a live concert, and/or any other suitable type of streaming live content), electronic books, and/or any other suitable type of media content. Media content can be created and uploaded to media content server 402 by any suitable entity. In some embodiments, media content server 402 can be omitted.

Data server 406 can be any suitable server for storing data, programs, and/or any other suitable information. For example, in instances where a user has consented to use of previously watched media content items to select and/or create media interfaces, data server 406 can store information relating to media content items a user has previously watched. As a more particular example, in some embodiments, data server 406 can store indications of media content items watched by a user, indications of one or more genres frequently watched by a user, and/or any other suitable information. In some embodiments, data server 406 can transmit indications of media content items a user has previously watched to media interface server 402. In some embodiments, data server 406 can be omitted.

Communication network 408 can be any suitable combination of one or more wired and/or wireless networks in some embodiments. For example, communication network 308 can include any one or more of the Internet, a mobile data network, a satellite network, a local area network, a wide area network, a telephone network, a cable television network, a WiFi network, a WiMax network, and/or any other suitable communication network.

User devices 410 can include any one or more user devices suitable for receiving and/or presenting audio content. For example, in some embodiments, user devices 410 can include mobile devices, such as a mobile phone, a tablet computer, a laptop computer, a vehicle (e.g., a car, boat, airplane, or any other suitable vehicle) entertainment system, a portable media player, or any other suitable mobile device. As another example, in some embodiments, user devices 410 can include non-mobile devices such as a desktop computer, a set-top box, a television, a streaming media player, a game console, or any other suitable non-mobile device.

Although media interface server 402, media content server 404, and data server 406 are illustrated as separate devices, any one or more of these devices can be combined into one device in some embodiments. Also, although only one each of media interface server 402, media content server 404, and data server 406 are shown in FIG. 4 to avoid over-complicating the figure, any suitable one or more of each device can be used in some embodiments.

Although two user devices 412 and 414 are shown in FIG. 4 to avoid over-complicating the figure, any suitable number of each of these devices, and any suitable types of these devices, can be used in some embodiments.

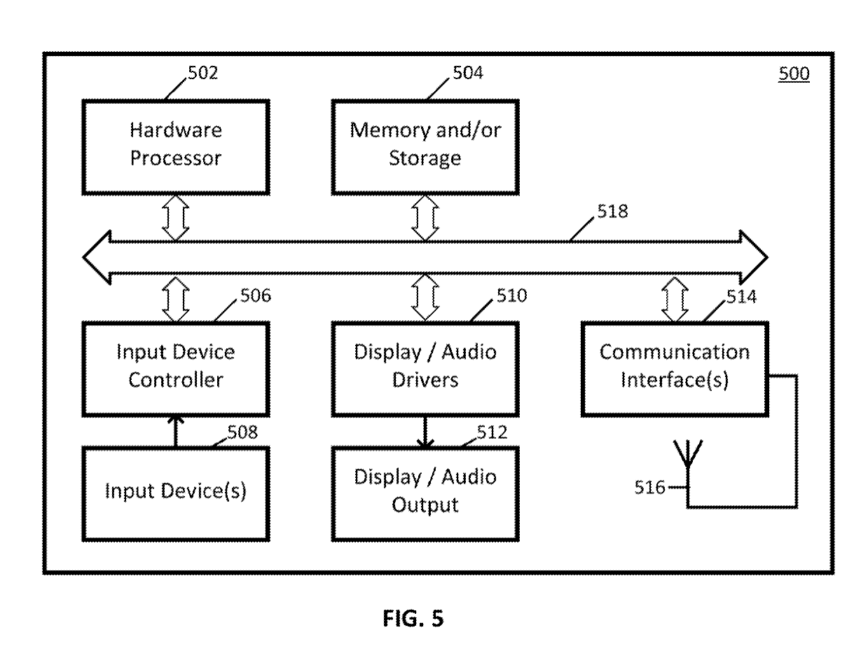

Media interface server 402, media content server 404, data server 406, and user devices 410 can be implemented using any suitable hardware in some embodiments. For example, in some embodiments, devices 402, 404, 406, and 410 can be implemented using any suitable general purpose computer or special purpose computer. For example, a mobile phone may be implemented using a special purpose computer. Any such general purpose computer or special purpose computer can include any suitable hardware. For example, as illustrated in example hardware 500 of FIG. 5, such hardware can include hardware processor 502, memory and/or storage 504, an input device controller 506, an input device 508, display/audio drivers 510, display and audio output circuitry 512, communication interface(s) 514, an antenna 516, and a bus 518.

Hardware processor 502 can include any suitable hardware processor, such as a microprocessor, a micro-controller, digital signal processor(s), dedicated logic, and/or any other suitable circuitry for controlling the functioning of a general purpose computer or a special purpose computer in some embodiments.

Memory and/or storage 504 can be any suitable memory and/or storage for storing programs, data, media content, and/or any other suitable information in some embodiments. For example, memory and/or storage 504 can include random access memory, read-only memory, flash memory, hard disk storage, optical media, and/or any other suitable memory.

Input device controller 506 can be any suitable circuitry for controlling and receiving input from one or more input devices 508 in some embodiments. For example, input device controller 506 can be circuitry for receiving input from a touch screen, from a remote control, from a game console, from a keyboard, from a mouse, from one or more buttons, from a voice recognition circuit, from a microphone, from a camera, from an optical sensor, from an accelerometer, from a temperature sensor, from a near field sensor, and/or any other type of input device.

Display/audio drivers 510 can be any suitable circuitry for controlling and driving output to one or more display/audio output circuitries 512 in some embodiments. For example, display/audio drivers 510 can be circuitry for driving an LCD display, a speaker, an LED, or any other type of output device.

Communication interface(s) 514 can be any suitable circuitry for interfacing with one or more communication networks, such as network 408 as shown in FIG. 4. For example, interface(s) 514 can include network interface card circuitry, wireless communication circuitry, and/or any other suitable type of communication network circuitry.

Antenna 516 can be any suitable one or more antennas for wirelessly communicating with a communication network in some embodiments. In some embodiments, antenna 516 can be omitted when not needed.

Bus 518 can be any suitable mechanism for communicating between two or more components 502, 504, 506, 510, and 514 in some embodiments.

Any other suitable components can be included in hardware 500 in accordance with some embodiments.

Turning to FIG. 6, an example 600 of a process for generating and presenting one or more media interfaces related to a first media interface is illustrated in accordance with some embodiments of the disclosed subject matter.

Process 600 can begin by causing a first media interface representing a single media content item or a playlist of media content items to be presented. The first media interface can be presented in any suitable manner. For example, in some embodiments, the first media interface can be presented concurrently with a presentation of a media content item represented by the first media interface, as shown in and described in connection with FIGS. 1A and 1B. Process 600 can cause the first media interface to be presented using any suitable technique or combination of techniques. For example, in some embodiments, the first media interface can be served from media interface server 402 to user device 410 via communication network 408. In such embodiments, the received media interface can be either displayed immediately by user device 410 or can be stored in memory 504 for future presentation.

Process 600 can determine if one or more additional media interfaces are to be presented at 604 based on any suitable information. For example, in some embodiments, process 600 can determine that an additional and/or alternative media interface is to be presented in response to determining that an indicator (e.g., play related videos interface 116 as shown in and described in connection with FIG. 1A) associated with the first media interface has been selected. As a more particular example, process 600 can determine that a media interface representing media content related to media content currently being presented is to be generated and presented.

As another example, in some embodiments, process 600 can determine that one or more additional and/or alternative media interfaces are to be presented in response to determining that all or nearly all of the media content items contained in a playlist represented by the first media interface have been viewed. In some embodiments, process 600 can determine that all of the media content items have been viewed if each media content item has been presented for a particular amount of time (e.g., 10% of the media content item has been presented, 50% of the media content item has been presented, all of the media content item has been presented, and/or any other suitable amount of time).

In yet another example, in some embodiments, process 600 can determine that one or more additional and/or alternative media interfaces are to be presented in response to determining that all or nearly all of the media content item contained in a playlist represented by the first media interface have been navigated through (e.g., in response to providing particular directional inputs from a user input device). In some embodiments, a media playback device executing process 600 can transmit an indicator that the last media content item in a playlist of media content items has been reached.

If process 600 determines that one or more additional media interfaces are not to be presented (“No” at 604), process 600 can loop back to 602 and can continue presenting the first media interface.

If process 600 determines that one or more additional media interfaces are to be presented (“Yes” at 604), process 600 can generate at least one additional and/or alternative media interface at 606. In some embodiments, the one or more additional media interfaces generated by process 600 can each represent either a single media content item or a playlist of media content items.

Process 600 can generate the additional media interface(s) based on any suitable information and any suitable technique or combination of techniques. For example, in some embodiments, process 600 can select and/or generate the media interface(s) by first identifying media content associated with metadata which is determined to be relevant to metadata associated with the first media interface and/or media content associated with the first media interface. As a more particular example, if process 600 determines that a media interface which represents a single media content item is to be generated, process 600 can identify a media content item that is associated with metadata determined to be relevant and/or similar to metadata associated with the first media interface and/or media content associated with the first media interface. As another more particular example, if process 600 determines that a media interface which represents a playlist of media content items is to be generated, process 600 can identify an existing playlist that is associated with metadata determined to be relevant and/or similar to metadata associated with the first media interface and/or media content associated with the first media interface. As yet another more particular example, if process 600 determines that a media interface which represents a playlist is to be generated, process 600 can compile a playlist by identifying any suitable number of media content items (e.g., five, ten, twenty, and/or any other suitable number) which are each associated with metadata determined to be relevant and/or similar to metadata associated with the first media interface and/or media content associated with the first media interface. Note that, in some embodiments, metadata can include a name of a creator of the media content, a name of an artist associated with the media content, a name of a creator of a playlist of media content items, a place of creation of the media content, a keyword associated with the media content, a genre of the media content, a publisher of the media content, a title of the media content, and/or any other suitable information.

Additionally or alternatively, in some embodiments, process 600 can select and/or generate the media interface(s) by determining media content items a user has shown a particular level of interest in. For example, if process 600 determines that a user tends to skip over a particular type of media content (e.g., media content of a particular genre, media content from a particular artist, and/or any other suitable type), process 600 can generate media interfaces which do not represent the particular type of media content. As another example, if process 600 determines that a user has re-played media content of a particular type, process 600 can generate media interfaces which represent the particular type of media content. In instances where a user consents to use of prior watching habits to generate media interfaces with suggestions of related content, process 600 can receive information indicating user preferences from data server 406.

It should be noted that a media playback device executing process 600 can generate and/or select additional media interfaces, such as related media interfaces, based on any suitable criterion—e.g., media interfaces that include media content owned by, created by, etc., the same or an overlapping group of entities and/or individuals; media interfaces that include media content that are part of a predetermined group of media assets, such as a television series, an album, a series of movies, a series of books, a user created playlist, an automatically generated playlist, etc.; media interfaces that include media content where users actively or passively indicated interest (e.g., by selecting a “thumbs up” icon or a “like” button, by watching the entirety of a video, by not skipping an audio track, etc.); media interfaces that are selected randomly; media interfaces that are selected based on popularity; any suitable combination of media interfaces thereof; and/or media interfaces generated and/or selected using any other suitable technique.

Process 600 can generate the media interface(s) using any suitable technique or combination of techniques. For example, in some embodiments, hardware processor 502 on media interface server 402 can receive information (e.g., a title, a name of a creator, a number of views, a thumbnail image, and/or any other suitable information) associated with related media content that is to be represented by the media interface(s) and can populate a media interface using the received information. As a more particular example, in some embodiments, hardware processor 502 can populate a media interface with a title, a thumbnail image, and/or a playlist indicator as shown in and described in connection with FIGS. 2A and 2B, and 3A-3C.

Process 600 can cause one or more of the generated media interface(s) to be presented on user device 410 at 608. The generated media interface(s) can be presented in any suitable manner. For example, in some embodiments, a generated media interface can be presented concurrently with a presentation of the media content associated with the generated media interface, as shown in and described above in connection with FIG. 2A. As another example, in some embodiments, the generated media interfaces can replace and/or relocate (e.g., shift, slide, and/or otherwise reposition) a corresponding number of media interfaces in a collection of media interfaces, as shown in and described above in connection with FIG. 2B. As yet another example, in some embodiments, a generated media interface can be presented in a manner that allows a user to navigate through media content items in a playlist represented by the generated media interface, as shown in and described above in connection with FIGS. 3A-3C.

Process 600 can cause the media interface(s) to be presented using any suitable technique or combination of techniques. For example, in some embodiments, the media interface(s) and/or any associated rendering instructions can be transmitted from media interface server 402 to user device 410 via communication network 408. Hardware processor 502 on user device 410 can then cause the media interface(s) to be presented on display/audio output 512 (e.g., by presenting the media interfaces on a touchscreen, a monitor, and/or any other suitable output device).

In instances where the presented media interface represents a playlist of media content items, process 600 can additionally receive user inputs to navigate in a particular direction (e.g., to the right, to the left, up, down, and/or any other suitable direction) and can subsequently cause a corresponding media interface to be a focus of the user interface in which it is presented. For example, if a second media interface is presented to the right of the first media interface, process 600 can cause the second media interface to be a focus of the user interface (as shown in FIG. 3B) in response to receiving a user input indicating that the user wants to navigate to the right. Furthermore, in such embodiments, additional user inputs can cause process 600 to allow a user to scroll through media content items contained in a playlist represented by the second media interface (as shown in FIG. 3C). Additionally or alternatively, in some embodiments, process 300 can cause a third media interface representing a new related media content item and/or a new related playlist to be presented in the media player window upon determining that all of the media content items represented by the second media interface have been viewed.

In some embodiments, process 600 can loop back to 602. In some embodiments, a second media interface that was generated and/or presented at blocks 606 and/or 608 can become the first media interface presented at block 602.

It should be understood that at least some of the above described blocks of the process of FIG. 6 can be executed or performed in any order or sequence not limited to the order and sequence shown in and described in the figures. Also, some of the above blocks of FIG. 6 can be executed or performed substantially simultaneously where appropriate or in parallel to reduce latency and processing times. Additionally or alternatively, some of the above described blocks of process of FIG. 6 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as magnetic media (such as hard disks, floppy disks, and/or any other suitable magnetic media), optical media (such as compact discs, digital video discs, Blu-ray discs, and/or any other suitable optical media), semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems described here collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for presenting related content, comprising:
causing a first media interface to be presented, wherein the first media interface represents a first plurality of media content items and wherein a first metadata is associated with the first media interface;
determining, using a hardware processor, that at least one media interface representing related content should be presented;
in response to determining that at least one media interface representing related content should be presented, generating a plurality of media interfaces, wherein each of the plurality of media interfaces is associated with metadata related to the first metadata; and
causing at least one of the plurality of media interfaces to be presented concurrently with the first media interface.

2. The method of claim 1, wherein at least one of the plurality of media interfaces represents a single media content item.

3. The method of claim 2, further comprising causing the single media content item to be presented in response to selecting one of the plurality of media interfaces.

4. The method of claim 1, wherein at least one of the plurality of media interfaces represents a plurality of media content items.

5. The method of claim 1, further comprising causing an indicator associated with the first media interface to be presented, wherein a selection of the indicator causes related content represented by one or more of the plurality of media content to be presented.

6. The method of claim 1, further comprising:
determining that each of the media content items in the first plurality of media content items has been viewed, wherein the at least one of the plurality of media interfaces is presented adjacent to the first media interface in response to determining that each of the media content items in the first plurality of media content items has been viewed.

7. The method of claim 6, further comprising, in response to receiving a first user input to navigate in a first direction, causing the at least one of the plurality of media interfaces to be selected, wherein a second plurality of media content items associated with the selected media interface is presented for browsing.

8. The method of claim 7, further comprising:
in response to receiving a second user input to navigate in the first direction, determining whether each of the media content items in the second plurality of media content items has been viewed; and
in response to determining that each of the media content items in the second plurality of media content items has been viewed, causing the at least one of the plurality of media interfaces to be selected, wherein a third plurality of media content items associated with the selected media interfaces is presented for browsing.

9. A system for presenting related content, comprising:
a hardware processor that is configured to:
cause a first media interface to be presented, wherein the first media interface represents a first plurality of media content items and wherein a first metadata is associated with the first media interface;
determine that at least one media interface representing related content should be presented;
in response to determining that at least one media interface representing related content should be presented, generate a plurality of media interfaces, wherein each of the plurality of media interfaces is associated with metadata related to the first metadata; and
cause at least one of the plurality of media interfaces to be presented concurrently with the first media interface.

10. The system of claim 9, wherein at least one of the plurality of media interfaces represents a single media content item.

11. The system of claim 10, wherein the hardware processor is further configured to cause the single media content item to be presented in response to selecting one of the plurality of media interfaces.

12. The system of claim 9, wherein at least one of the plurality of media interfaces represents a plurality of media content items.

13. The system of claim 9, wherein the hardware process is further configured to cause an indicator associated with the first media interface to be presented, wherein a selection of the indicator causes related content represented by one or more of the plurality of media content to be presented.

14. The system of claim 9, wherein the hardware processor is further configured to:
determine that each of the media content items in the first plurality of media content items has been viewed, wherein the at least one of the plurality of media interfaces is presented adjacent to the first media interface in response to determining that each of the media content items in the first plurality of media content items has been viewed.

15. The system of claim 14, wherein the hardware processor is further configured to, in response to receiving a first user input to navigate in a first direction, cause the at least one of the plurality of media interfaces to be selected, wherein a second plurality of media content items associated with the selected media interface is presented for browsing.

16. The system of claim 15, wherein the hardware processor is further configured to:
in response to receiving a second user input to navigate in the first direction, determine whether each of the media content items in the second plurality of media content items has been viewed; and
in response to determining that each of the media content items in the second plurality of media content items has been viewed, cause the at least one of the plurality of media interfaces to be selected, wherein a third plurality of media content items associated with the selected media interfaces is presented for browsing.

17. A non-transitory computer-readable medium containing computer executable instructions that, when executed by a processor, cause the processor to perform a method for presenting related content, the method comprising:
causing a first media interface to be presented, wherein the first media interface represents a first plurality of media content items and wherein a first metadata is associated with the first media interface;
determining that at least one media interface representing related content should be presented;
in response to determining that at least one media interface representing related content should be presented, generating a plurality of media interfaces, wherein each of the plurality of media interfaces is associated with metadata related to the first metadata; and
causing at least one of the plurality of media interfaces to be presented concurrently with the first media interface.

18. The non-transitory computer-readable medium of claim 17, wherein at least one of the plurality of media interfaces represents a single media content item.

19. The non-transitory computer-readable medium of claim 18, wherein the method further comprises causing the single media content item to be presented in response to selecting one of the plurality of media interfaces.

20. The non-transitory computer-readable medium of claim 17, wherein at least one of the plurality of media interfaces represents a plurality of media content items.

21. The non-transitory computer-readable medium of claim 17, wherein the method further comprises causing an indicator associated with the first media interface to be presented, wherein a selection of the indicator causes related content represented by one or more of the plurality of media content to be presented.

22. The non-transitory computer-readable medium of claim 17, wherein the method further comprises:
determining that each of the media content items in the first plurality of media content items has been viewed, wherein the at least one of the plurality of media interfaces is presented adjacent to the first media interface in response to determining that each of the media content items in the first plurality of media content items has been viewed.

23. The non-transitory computer-readable medium of claim 22, wherein the method further comprises, in response to receiving a first user input to navigate in a first direction, causing the at least one of the plurality of media interfaces to be selected, wherein a second plurality of media content items associated with the selected media interface is presented for browsing.

24. The non-transitory computer-readable medium of claim 23, wherein the method further comprises:
in response to receiving a second user input to navigate in the first direction, determining whether each of the media content items in the second plurality of media content items has been viewed; and
in response to determining that each of the media content items in the second plurality of media content items has been viewed, causing the at least one of the plurality of media interfaces to be selected, wherein a third plurality of media content items associated with the selected media interfaces is presented for browsing.
